(19) United States
(12) Patent Application Publication
(10) Pub. No.: US 2016/0315858 A1
(43) Pub. Date: Oct. 27, 2016

(54) LOAD BALANCING OF IPV6 TRAFFIC IN AN IPV4 ENVIRONMENT

(71) Applicant: CISCO TECHNOLOGY, INC., San Jose, CA (US)

(72) Inventors: Mouli Vytla, San Jose, CA (US); Samar Sharma, San Jose, CA (US)

(73) Assignee: CISCO TECHNOLOGY, INC., San Jose, CA (US)

(21) Appl. No.: 14/802,518

(22) Filed: Jul. 17, 2015

Related U.S. Application Data
(60) Provisional application No. 62/152,164, filed on Apr. 24, 2015.

(51) Int. Cl. H04L 12/56; H04L 29/08

(52) U.S. Cl. CPC H04L 45/741; H04L 67/1023

(57) ABSTRACT

A method is provided in one example and includes receiving a data stream that includes IPv6 traffic, communicating the IPv6 traffic to a network element that does not support IPv6 probing, and probing the network element using IPv4.

### CROSS-REFERENCE TO RELATED APPLICATION

This application claims the benefit of priority under 35 U.S.C. §119(e) to U.S. Provisional Application No. 62/152,164, entitled “LOAD BALANCING OF IPV6 TRAFFIC IN AN IPV4 ENVIRONMENT” filed in the U.S. Patent Office on Apr. 24, 2015, which is hereby incorporated by reference in its entirety.

### TECHNICAL FIELD

This disclosure relates in general to the field of communications and, more particularly, to load balancing of IPv6 traffic in an IPV4 environment.

### BACKGROUND

End users have more communications choices than ever before. A number of prominent technological trends are currently afoot (e.g., more computing devices, more online video services, more Internet video traffic), and these trends are changing the network delivery landscape. The Internet, which currently handles a majority of the communications, is a global system of interconnected computer networks that use a standard Internet Protocol suite (TCP/IP) to link several billion devices worldwide. Internet Protocol version 4 (IPv4) was the first publicly used version of the Internet Protocol (IP) but as use of the Internet continues to grow, a new IP was needed. IP version 6 (IPv6) is the most recent version of the IP and provides an improved identification and location system for computers on networks and routes traffic across the Internet. Not all systems and networks can transfer from IPv4 to IPv6 at the same time. Hence, there is a challenge in providing IPv6 communications while still using some IPv4 features.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system in accordance with one embodiment of the present disclosure;

FIG. 2 is a simplified block diagram illustrating possible example details associated with the communication system in accordance with one embodiment of the present disclosure;

FIG. 3 is a simplified flowchart illustrating potential operations associated with the communication system;

FIG. 4 is another simplified block diagram illustrating possible example details associated with the communication system in accordance with one embodiment of the present disclosure; and

FIG. 5 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Overview

A method is provided in one example and includes a load balancing module configured to load balance IPv6 traffic in an IPv4 environment. In one implementation, the method may include communicating traffic to a network element using IPv6 and communicating probing data using IPv4. In some examples, the IPv4 probing data can include an Internet control message protocol (ICMP) probe, a transmission control protocol (TCP) probe, a domain name system (DNS) probe, user datagram protocol (UDP) probe, etc. Each probe can be customizable by a health monitoring module for frequency, timeout, etc. In addition, a plurality of probes can be specified.

In an example, a method can include receiving a data stream that includes IPv6 traffic, communicating the IPv6 traffic to a network element that does not support IPv6 probing, and probing the network element using IPv4. The probing can be customized where the customizing includes a customized frequency of the probe. Also, the customizing can includes a customized timeout period for the probe.

### Example Embodiments

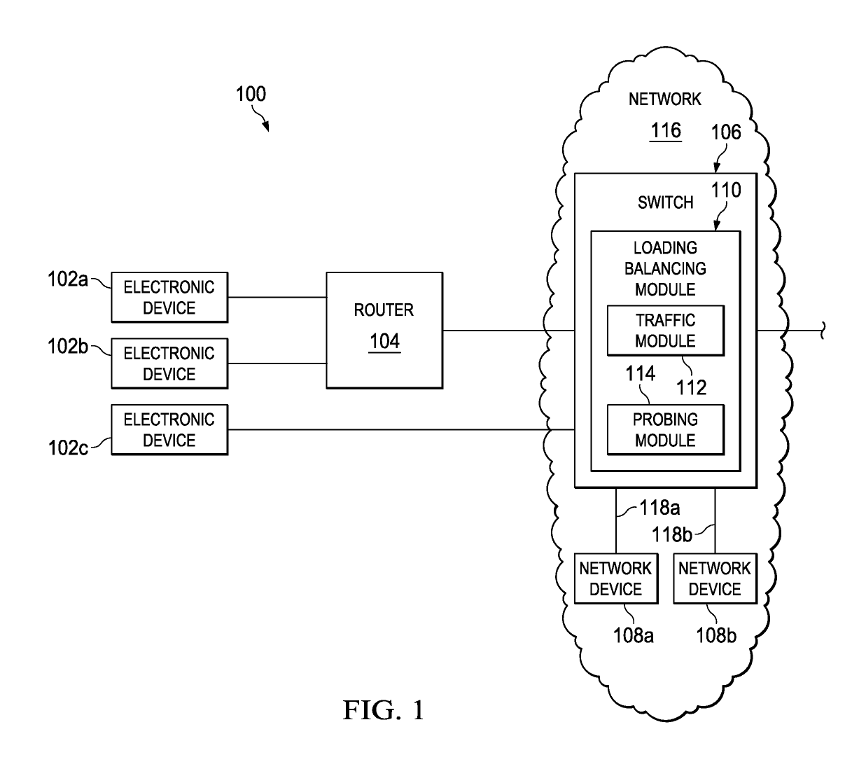

Turning to FIG. 1, FIG. 1 is a simplified block diagram of a communication system 100 for load balancing IPv6 traffic in an IPv4 environment in accordance with one embodiment of the present disclosure. FIG. 1 includes a plurality of electronic devices 102a-102c, a router 104, a switch 106, and one or more network devices 108a and 108b. Switch 106 can include a load balancing module 110. Load balancing module 110 can include a traffic module 112 and a health monitoring module 114. Switch 106 and one or more network devices 108a and 108b can be included in a network 116. Electronic devices 102a-102c can communicate with switch 106 using router 104, may communicate directly with switch 106, or may communicate with switch 106 using some other means. Switch 106 can communicate with each network device 108a and 108b and can be configured to load balance some of the network traffic in network 116.

The term “load balancing” includes distributing workloads across multiple computing resources, such as computers, a computer cluster, network links, central processing units or disk drives and aims to optimize or improve resource use, maximize throughput, minimize response time, and avoid overload of any single resource. For example, network path 118a may be used to load balance or otherwise communicate with network device 108a. In addition, network path 118b may be used to load balance or otherwise communicate with network device 108b.

For purposes of illustrating certain example techniques of communication system 100, it is important to understand how typical communications may traverse the network. The following foundational information may be viewed as a basis from which the present disclosure may be properly explained.

The Internet is a global system of interconnected computer networks that uses a standard Internet protocol suite (TCP/IP) to link several billion devices worldwide and consists of millions of private, public, academic, business, and government networks of local to global scope, linked by a broad array of electronic, wireless, and optical networking technologies. The Internet carries an extensive range of information resources and services, such as the inter-linked hypertext documents and applications of the World Wide Web (WWW), the infrastructure to support email, and peer-to-peer networks for file sharing and telephony. IPv4 was the first publicly used version of the Internet Protocol (IP) and currently routes most traffic on the Internet. However, due to the exponential increase in network traffic and the need for a more efficient IP, a successor protocol, IPv6, was developed. IPv6 specifies a new packet format, designed to minimize packet header processing by routers. Because the headers of IPv4 packets and IPv6 packets are significantly different, the two protocols are not interoperable. This can create a problem as the transition from IPv4 to IPv6 cannot happen all at once. What is needed is a system and method that can load balance IPv6 traffic in an IPv4 environment.

A communication system for load balancing IPv6 traffic in an IPv4 environment, as outlined in FIG. 1, can resolve these issues (and others). Communication system 100 may be configured to use current IPv4 health monitoring functionality of a network device when the network device does not support IPv6 health monitoring probes and allow migration to IPv6 networks without losing health monitoring. This allows for a mixed use of IPv6 and IPv4 and helps with IPv6 migration by coupling IPv4 probes with IPv6 traffic functionality.

Communication system 100 can be configured to communicate traffic to a network element using IPv6 and communicate probing data using IPv4. For example, the IPv4 probing data can include an Internet control message protocol (ICMP) probe, a transmission control protocol (TCP) probe, a domain name system (DNS) probe, user datagram protocol (UDP) probe, etc. Each probe can be customizable by a health monitoring module for frequency, timeout, etc.

ICMP is an internet-standard protocol used to collect response time, service availability, and packet loss information for network devices, such as routers, on an IP network. An ICMP probe can collect this information by sending ICMP echo requests at defined intervals and waiting for the network element to return an ICMP echo response. The echo response contains the ICMP message from the echo request when the echo request does not encounter any network issues. If an error condition is encountered, such as the router identified in the echo request is unreachable, the echo response returns with an ICMP error in the packet. If ping has been disabled on a device, the ICMP probe generates an unreachable Q0S message.

The TCP is a core protocol of the Internet Protocol Suite and provides reliable, ordered, and error-checked delivery of a stream of octets between applications running on hosts communicating over an IP network. TCP is the protocol that major Internet applications such as the World Wide Web, email, remote administration and file transfer rely on. A TCP probe is typically a module that records the state of a TCP connection in response to incoming packets. TCP probes can connect to a specified device and port, then execute a script that sends and receives data from the specified device and port. Applications that do not require reliable data stream service may use UDP, which provides a connectionless datagram service that emphasizes reduced latency over reliability.

DNS is a hierarchical distributed naming system for computers, services, or any resource connected to the Internet or a private network and associates various information with domain names assigned to each of the participating entities. Most prominently, DNS translates domain names to the numerical IP addresses needed for the purpose of computer services and devices worldwide. Using IPv4 health monitoring functionality such as ICMP probes, TCP probes, DNS probes, UDP probes, etc. when the network device does not support IPv6 health monitoring can allow migration from IPv4 networks to IPv6 networks without losing health monitoring.

Turning to the infrastructure of FIG. 1, communication system 100 in accordance with an example embodiment is shown. Generally, communication system 100 can be implemented in any type or topology of networks. Network 116 represents a series of points or nodes of interconnected communication paths for receiving and transmitting packets of information that propagate through communication system 100. Network 116 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication systems 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, switch 106 and network devices 108a and 108b are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, electronic devices 102a-102c, switch 106, and network devices 108a and 108b can include memory elements for storing information to be used in the operations outlined herein. Electronic devices 102a-102c, switch 106, and network devices 108a and 108b may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as switch 106 may include software modules (e.g., load balancing module 110, traffic module 112, and health monitoring module 114) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, electronic devices 102a-102c, switch 106, and network devices 108a and 108b may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic devices 102a-102c can each be a network element and include, for example, desktop computers, laptop computers, mobile devices, personal digital assistants, smartphones, tablets, or other similar devices. Switch 106 may be an intelligent traffic director or some other similar type device. Network devices 108a and 108b may be a firewall, server, or any other similar device used for network communications. The term ‘server’ is inclusive of devices used to serve the requests of clients and/or perform some computational task on behalf of clients within communication systems 100.

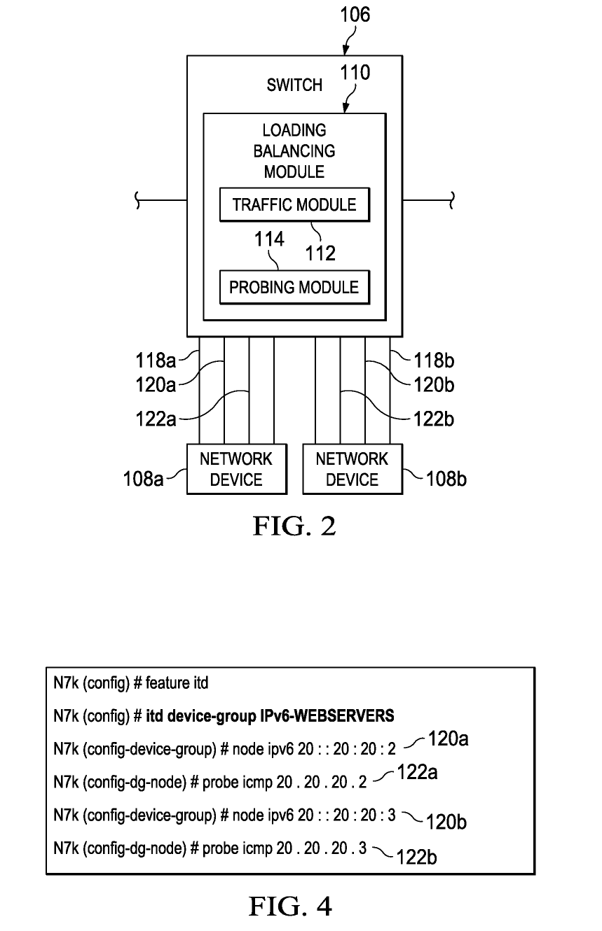

Turning to FIG. 2, FIG. 2 is a simplified block diagram illustrating one possible set of details associated communication system 100. Communication system 100 can be configured to include a network path for communicating traffic to a network element using IPv6 and communicating probing data using IPv4. For example, network path 118a can include a data or traffic channel 120a and a probe channel 122a. Data or traffic channel 120a can be configured to communicate IPv6 data or traffic to network device 108a and probe channel 122a can be configured to communicate probing data to network device 108a. In an example, the probing data on probe channel 122a can include IPv4 probing data. Further, network path 118b can include a data or traffic channel 120b and a probe channel 122b. Data or traffic channel 120b can be configured to communicate IPv6 data or traffic to network device 108b and probe channel 122b can be configured to communicate probing data to network device 108b. In an example, the probing data on probe channel 122b can include IPv4 probing data.

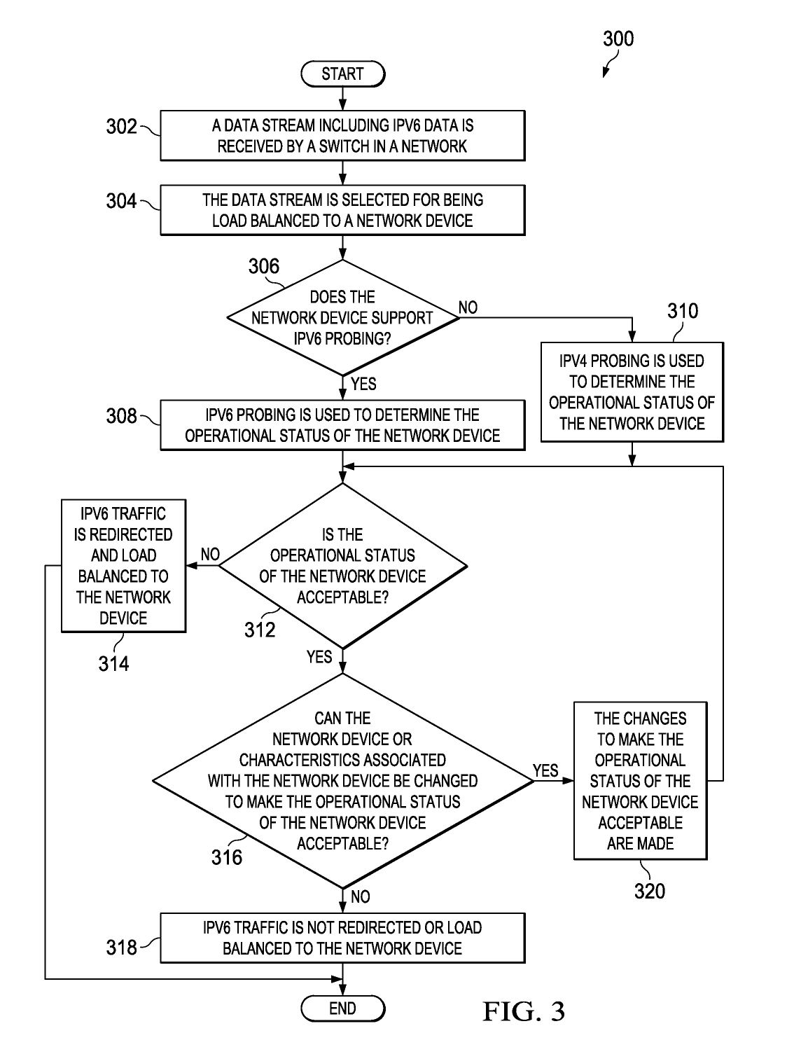

Turning to FIG. 3, FIG. 3 is a simplified flowchart 300 illustrating one potential operation associated with the present disclosure. At 302, a data stream is received by a switch in a network. At 304, the data stream is selected for being load balanced to a network device. At 306, the system determines if the network device supports IPv6 probing. If the network device does support IPv6 probing, then IPv6 probing is used to determine the operational status of the network device, as in 308. If the network device does not support IPv6 probing, then IPv4 probing is used to determine the operational status of the network device, as in 310. At 312, the system determines if the operation status of the network device is acceptable. For example, IPv4 or IPv6 probing can be used to determine a response time, service availability, and packet loss information for the network device. If the operational status of the network device is acceptable, then IPv6 traffic is redirected and load balanced to the network device, as in 314. If the operational status of the network device is not acceptable, then the system determines if the network device or characteristics associated with the network device can be changed to make the operational status of the network device acceptable, as in 316. If the network device or characteristics associated with the network device can be changed to make the operational status of the network device acceptable, then the changes to make the operational status of the network device acceptable are made, as in 320 and the system determines if the operation status of the network device is acceptable, as in 312. If the network device or characteristics associated with the network device cannot be changed to make the operational status of the network device acceptable, then IPv6 traffic is not redirected or load balanced to the network device, as in 318.

Turning to FIG. 4, FIG. 4 is a simplified block diagram illustrating one possible set of details associated communication system 100. As illustrated in FIG. 4, data or traffic channel 120a can be configured to communicate IPv6 data or traffic to network device 108a and probe channel 122a can be configured to communicate probing data to network device 108a. Further, data or traffic channel 120b can be configured to communicate IPv6 data or traffic to network device 108b and probe channel 122b can be configured to communicate probing data to network device 108b.

Note that in certain example implementations, the load balancing of IPv6 traffic in an IPv4 environment functions outlined herein may be implemented in logic encoded in one or more non-transitory media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element can store data used for the operations described herein. This includes the memory element being able to store code (e.g., software, logic, processor instructions, etc.) that can be executed to carry out the activities described in this Specification. A processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

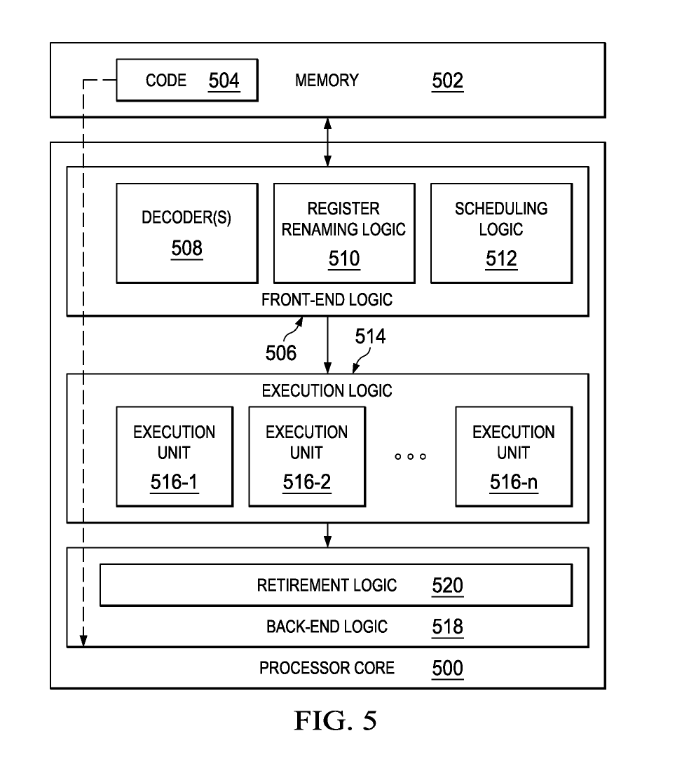

FIG. 5 illustrates a processor core 500 according to an embodiment. Processor core 500 may be the core for any type of processor, such as a micro-processor, an embedded processor, a digital signal processor (DSP), a network processor, or other device to execute code. Although only one processor core 500 is illustrated in FIG. 5, a processor may alternatively include more than one of the processor core 500 illustrated in FIG. 5. Processor core 500 may be a single-threaded core or, for at least one embodiment, processor core 500 may be multithreaded in that it may include more than one hardware thread context (or “logical processor”) per core.

FIG. 5 also illustrates a memory 502 coupled to processor core 500 in accordance with an embodiment. Memory 502 may be any of a wide variety of memories (including various layers of memory hierarchy) as are known or otherwise available to those of skill in the art. Memory 502 may include code 504, which may be one or more instructions, to be executed by processor core 500. Processor core 500 can follow a program sequence of instructions indicated by code 504. Each instruction enters a front-end logic 506 and is processed by one or more decoders 508. The decoder may generate, as its output, a micro operation such as a fixed width micro operation in a predefined format, or may generate other instructions, microinstructions, or control signals that reflect the original code instruction. Front-end logic 506 also includes register renaming logic 510 and scheduling logic 512, which generally allocate resources and queue the operation corresponding to the instruction for execution.

Processor core 500 can also include execution logic 514 having a set of execution units 516-1 through 516-N. Some embodiments may include a number of execution units dedicated to specific functions or sets of functions. Other embodiments may include only one execution unit or one execution unit that can perform a particular function. Execution logic 514 performs the operations specified by code instructions.

After completion of execution of the operations specified by the code instructions, back-end logic 518 can retire the instructions of code 504. In one embodiment, processor core 500 allows out of order execution but requires in order retirement of instructions. Retirement logic 520 may take a variety of known forms (e.g., re-order buffers or the like). In this manner, processor core 500 is transformed during execution of code 504, at least in terms of the output generated by the decoder, hardware registers and tables utilized by register renaming logic 510, and any registers (not shown) modified by execution logic 514.

Although not illustrated in FIG. 5, a processor may include other elements on a chip with processor core 500. For example, a processor may include memory control logic along with processor core 500. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and their teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagram (i.e., FIG. 3) illustrates only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 has been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a data stream that includes IPv6 traffic;
communicating the IPv6 traffic to a network element that does not support IPv6 probing; and
probing the network element using IPv4.

2. The method of claim 1, wherein the probing includes an Internet control message protocol (ICMP) probe.

3. The method of claim 1, wherein the probing includes a transmission control protocol (TCP) probe.

4. The method of claim 1, wherein the probing includes a domain name system (DNS) probe.

5. The method of claim 1, wherein the probing includes a user datagram protocol (UDP) probe.

6. The method of claim 1, further comprising:
customizing the probing of the network element, wherein the customizing includes a customized frequency of the probe.

7. The method of claim 1, further comprising:
customizing the probing of the network element, wherein the customizing includes a customized timeout period for the probe.

8. Logic encoded in one or more tangible media that includes code for execution and when executed by a processor operable to perform operations comprising:
receiving a data stream that includes IPv6 traffic;
communicating the IPv6 traffic to a network element that does not support IPv6 probing; and
probing the network element using IPv4.

9. The logic of claim 8, wherein the probing includes an Internet control message protocol (ICMP) probe.

10. The logic of claim 8, wherein the probing includes a transmission control protocol (TCP) probe.

11. The logic of claim 8, wherein the probing includes a domain name system (DNS) probe.

12. The logic of claim 8, wherein the probing includes a user datagram protocol (UDP) probe.

13. The logic of claim 8, further comprising:
customizing the probing of the network element, wherein the customizing includes a customized frequency of the probe.

14. An apparatus, comprising:
a memory element configured to store data,
a processor operable to execute instructions associated with the data, and
a load balancing module configured to:
receive a data stream that includes IPv6 traffic;
communicate the IPv6 traffic to a network element that does not support IPv6 probing; and
probe the network element using IPv4.

15. The apparatus of claim 14, wherein the probing includes an Internet control message protocol (ICMP) probe.

16. The apparatus of claim 14, wherein the probing includes a transmission control protocol (TCP) probe.

17. The apparatus of claim 14, wherein the probing includes a domain name system (DNS) probe.

18. The apparatus of claim 14, wherein the probing includes a user datagram protocol (UDP) probe.

19. The apparatus of claim 14, wherein the load balancing module is further configured to:
customize the probing of the network element, wherein the customizing includes a customized frequency of the probe.

20. The apparatus of claim 14, wherein the load balancing module is further configured to:
customizing the probing of the network element, wherein the customizing includes a customized timeout period for the probe.
